(19) United States
(12) Patent Application Publication
(10) Pub. No.: US 2008/0227901 A1
(43) Pub. Date: Sep. 18, 2008

(54) Use of Barium Sulfate or Calcium Carbonate Particles in Transparent Polymer Compositions, Transparent Polymer Compositions and Process for Manufacturing These Compositions

(75) Inventors: Benoit Lefevre, Arles (FR); Marc Lacroix, Louvain-La-Neuve (BE); Karine Cavalier, Arles (FR); Gaelle Rodary, Fos Sur Mer (FR); Julien Pineau, Salin De Giraud (FR); Christian Jourquin, Brussels (BE); Ferdinand Hardinghaus, Bad Honnef (DE); Jai-Won Park, Gottingen (DE); Karl Kohler, Diekholzen (DE); Jean-Raphael Caille, Namur (FR); Ardechir Momtaz, Brussels (BE)

Correspondence Address: Solvay North America, LLC;c/o Kim Manson, Esq., 4500 McGinnis Ferry Road, Alpharetta, GA, 30005, US

(73) Assignee: Solvay SA, Bussels (BE)

(21) Appl. No.: 12/089,130

(22) PCT Filed: Oct. 4, 2006
(86) PCT No.: PCT/EP2006/067039

§ 371 Date: Apr. 3, 2008

(30) Foreign Application Priority Data
Oct. 4, 2005 (FR) 05.10129

(51) Int. Cl. C08K 3/26; C08K 3/30

(52) U.S. Cl. 524/423; 524/425

(57) ABSTRACT

Use of nanoparticles of barium sulfate or of calcium carbonate, with a particle size of less than or equal to 150 nm and greater than or equal to 0.5 nm, as filler in transparent polymer compositions. The compositions obtained simultaneously show good scratch resistance, good impact strength, good tensile strength, good heat stability and good visible and UV radiation stability, while at the same time conserving excellent transparency. The compositions may be used as replacement materials for glass in the motor vehicle sector and in the optics sector.

The invention relates to the use of barium sulfate or calcium carbonate particles in polymer compositions. More specifically, it relates to the use of barium sulfate or calcium carbonate nanoparticles as filler in transparent polymer compositions.

Transparent polymer compositions are especially used as material for replacing glass in applications in which a weight reduction is targeted. This is the case, for example, in the motor vehicle sector in which the use in vehicles of transparent polymer compositions instead of heavy glazing structures (side windows, sunroof, etc.) would afford a weight gain of several tens of percent, with as a consequence a concomitant reduction in fuel consumption and all the implications that this entails, especially a reduction in the greenhouse effect. It is also the case in the optical sector (spectacles, optical instruments, etc.) for example, in which a reduction in weight would contribute towards improving the personal comfort of the user.

However, the use of transparent polymer compositions is at the present time fairly limited on account of certain remaining disadvantages compared with glass: lower scratch resistance, lower impact strength, less heat stability and ultraviolet (UV) radiation stability. Fillers are used with the aim of eliminating these drawbacks. However, it is difficult to simultaneously improve the mechanical, thermal and light-stability properties while at the same time conserving a high degree of transparency for the filled polymer composition.

The aim of the present invention is to provide transparent polymer compositions that have improved mechanical (scratch resistance, impact strength, tensile strength, etc.), thermal and light-stability (visible, ultraviolet) properties.

The invention then relates to the use of nanoparticles of barium sulfate or calcium carbonate, with a particle size of less than or equal to 150 nm and greater than or equal to 0.5 nm, as filler in transparent polymer compositions.

It has been discovered, surprisingly, that when barium sulfate or calcium carbonate nanoparticles are added as filler to a transparent polymer composition, good scratch resistance, good impact strength, good tensile strength, good heat stability and high visible and UV radiation stability are simultaneously obtained, while at the same time maintaining excellent transparency for the supplemented polymer composition.

Transparent polymer compositions into which barium sulfate or calcium carbonate nanoparticles have been incorporated may especially be used as glass substitution materials in the motor vehicle sector and the optics sector.

The barium sulfate nanoparticles used in the invention may be natural or synthetic barium sulfate particles. The natural barium sulfate may be natural barite. It may be dry-ground or ground in suspension beforehand. Synthetic barium sulfate is preferred. Precipitated barium sulphate is more preferred.

The calcium carbonate nanoparticles used in the invention may be natural or synthetic calcium carbonate particles. The natural calcium carbonate may be natural calcite or aragonite, chalk or marble. It may be dry-ground or ground in suspension beforehand. Synthetic calcium carbonate is preferred. Precipitated calcium carbonate is more preferred.

The barium sulfate or the calcium carbonate nanoparticles may consist of substantially amorphous or substantially crystalline barium sulfate or calcium carbonate. The term “substantially amorphous or crystalline” means that more than 50% by weight of the barium sulfate or the calcium carbonate, preferably more than 75% by weight and particularly preferably more than 90% by weight of the barium sulphate or of the calcium carbonate is in amorphous form or in crystalline form, when analysed by the X-ray diffraction technique or by the electron diffraction technique. Substantially crystalline barium sulfate is preferred. Substantially amorphous calcium carbonate is preferred.

The barium sulfate or calcium carbonate nanoparticles used according to the invention usually have a BET specific surface area of greater than or equal to 10 m²/g, often greater than or equal to 15 m²/g, frequently greater than or equal to 20 m²/g and particularly greater than or equal to 40 m²/g. A specific surface area of greater than or equal to 70 m²/g gives good results. These particles usually have a specific surface area of less than or equal to 300 m²/g, often less than 250 m²/g and frequently less than or equal to 150 m²/g. A specific surface area of less than or equal to 100 m²/g is suitable for use. The BET specific surface area of the particles is measured according to ISO standard 9277-1995.

The size of the nanoparticles of barium sulphate or of calcium carbonate can be measured by various techniques, like for instance, X-ray diffraction (XRD line broadening) technique, Centrifugal liquid Sedimentation (Standard ISO 13318-2, 2001), small-angle X-ray scattering (SAXS), Dynamic Light Scattering (standard ISO-DIS 22412, 2006) and air permeation (Lea and Nurse method, Standard NFX 11-601, 1974).

When analysed by the X-ray diffraction (XRD line broadening) technique, the barium sulfate or calcium carbonate nanoparticles have a volume weighed average size of less than or equal to 150 nm, preferably of less than or equal to 100, more preferably of less than or equal to 70 nm, yet more preferably of less than or equal to 40 nm, particularly preferably less than or equal to 25 nm and most particularly preferably less than or equal to 10 nm. A volume weighed average size of less than or equal to 5 nm gives particularly good results. This volume weighed average size is generally greater than or equal to 0.5 nm.

When analysed by the Centrifugal liquid Sedimentation method, the barium sulfate or calcium carbonate nanoparticles have a volume weighed average size of less than or equal to 150 nm, preferably of less than or equal to 100 nm, more preferably of less than or equal to 70 nm, yet more preferably of less than or equal to 40 nm, particularly preferably less than or equal to 25 nm and most particularly preferably less than or equal to 10 nm. A volume weighed average size of less than or equal to 5 nm gives particularly good results. This volume weighed average size is generally greater than or equal to 0.5 nm.

When analysed by the Dynamic Light Scattering technique (DLS), the barium sulfate or the calcium carbonate nanoparticles have an average diameter of less than or equal to 150 nm, preferably of less than or equal to 100 nm, more preferably of less than or equal to 70 nm, yet more preferably less than or equal to 40 nm, particularly preferably less than or equal to 25 nm and most particularly preferably less than or equal to 10 nm. An average diameter of less than or equal to 5 nm gives particularly good results. This average diameter is generally greater than or equal to 0.5 nm.

When analysed by the air permeation technique the barium sulfate or the calcium carbonate nanoparticles have an average diameter of less than or equal to 150 nm, preferably of less than or equal to 100 nm, more preferably of less than or equal to 70 nm, yet more preferably less than or equal to 40 nm, particularly preferably less than or equal to 25 nm and most particularly preferably less than or equal to 10 nm. An average diameter of less than or equal to 5 nm gives particularly good results. This average diameter is generally greater than or equal to 0.5 nm.

When analysed by the small-angle X-ray scattering (SAXS) technique in a solvent, like for instance toluene, the barium sulphate or the calcium carbonate nanoparticles have a scattering spectrum typical of spheres with a mean equivalent spherical diameter (ESD) of less than or equal to 150 nm, preferably of less than or equal to 100 nm, more preferably of less than or equal to 70 nm, yet more preferably less than or equal to 40 nm, particularly preferably less than or equal to 25 nm and most particularly preferably less than or equal to 10 nm. A mean ESD of less than or equal to 5 nm gives particularly good results. This equivalent spherical diameter is generally greater than or equal to 0.5 nm. The particle size distribution (PSD) is such that 90% by weight, preferably 95% by weight and particularly preferably 99% by weight of the particles have an ESD measured by SAXS of greater than or equal to 90% and less than or equal to 110% of the mean ESD.

The term “nanoparticles” is therefore intended to denote particles with a particle size of less than or equal to 150 nm and greater than or equal to 0.5 nm, the particle size being measured by, one of the following methods, X-ray diffraction (XRD line broadening) technique, Centrifugal liquid Sedimentation (Standard ISO 13318-2, 2001), small-angle X-ray scattering (SAXS), Dynamic Light Scattering (standard ISO-DIS 22412, 2006) or air permeation (Lea and Nurse method, Standard NFX 11-601, 1974).

If the size of the particles obtained by one of the previous method is of less than or equal to 150 nm and greater than or equal to 0.5 nm, the particles are considered as being according to the invention.

The invention thus also relates to the use of barium sulfate or calcium carbonate nanoparticles with a particle size of less than or equal to 150 nm and greater than or equal to 0.5 nm, the particle size being measured by one of the following methods, X-ray diffraction (XRD line broadening) technique or Centrifugal liquid Sedimentation (Standard ISO 13318-2, 2001) or small-angle X-ray scattering (SAXS) or Dynamic Light Scattering (standard ISO-DIS 22412, 2006) or air permeation (Lea and Nurse method, Standard NFX 11-601, 1974), as filler in transparent polymer compositions.

Barium sulfate particles may be used in the form of clusters or aggregates. At least 90% of the clusters have a size of less than 2 μm, preferably less than 1 μm. With particular preference at least 90% of the clusters have a size smaller than 250 nm, with very particular preference smaller than 200 nm. More preferably still at least 90% of the clusters have a size smaller than 130 nm, with particular preference smaller than 100 nm, with very particular preference smaller than 80 nm; more preferably still 90% of clusters have a size smaller than 50 nm, especially preferably less than 30 nm. In part or even in substantial entirety the barium sulfate is in the form of unaggregated particles. The average cluster size in question are those determined by Scanning Electron Microscopy.

The calcium carbonate nanoparticles used may be in the form of clusters or aggregates whose largest dimension is usually greater than or equal to 1 nm, often greater than or equal to 20 nm, frequently greater than or equal to 50 nm, more especially greater than or equal to 80 nm and most particularly greater than or equal to 140 nm. This largest dimension is usually less than 40 μm, often less than or equal to 4 μm, more specifically less than or equal to 1 μm and most particularly less than or equal to 0.3 μm. These aggregates usually have a smallest dimension of greater than or equal to 0.5 nm, frequently greater than or equal to 10 nm, often greater than or equal to 25 nm, more especially greater than or equal to 40 nm and most particularly greater than or equal to 70 nm. This smallest dimension is usually less than 10 μm, especially less than or equal to 0.7 μm and more specifically less than or equal to 0.2 μm. These dimensions are obtained by measuring the largest and the smallest dimension of individual particles observed in images obtained by scanning electron microscopy (SEM).

Without wishing to be bound by any theoretical explanation, it is thought that the interactions between the nanoparticles constituting the clusters or aggregates are weak, which facilitates their dispersion in polymer compositions.

According to one alternative, barium sulfate or calcium carbonate are used which have not been modified chemically.

The barium sulfate or calcium carbonate particles may contain at least one organic compound. The organic compound contains preferably at least one group capable of generating an anionic group. The anionic group is preferably selected from sulfate, sulfonate, phosphate, phosphonate and carboxylate groups.

The content of the organic compound in the nanoparticle of barium sulfate or calcium carbonate is generally greater than or equal to 0.01% by weight, often greater than or equal to 0.05% by weight, frequently greater than or equal to 0.1% by weight and most particularly greater than or equal to 1% by weight relative to the total weight of the particles. This content is usually less than 90% by weight, often less than or equal to 50% by weight, specifically less than or equal to 25% by weight, more specifically less than or equal to 10% by weight and most particularly less than or equal to 5% by weight.

For the barium sulfate particles, the organic compound can be a cristallisation inhibitor, a dispersing agent or a mixture thereof.

Preferred crystallization inhibitors have at least one anionic group. The anionic group of the crystallization inhibitor is preferably at least one sulfate, at least one sulfonate, at least one phosphate, at least two phosphonate or at least two carboxylate group(s).

Crystallization inhibitors present may be, for example, substances that are known to be used for this purpose, examples being relatively short-chain polyacrylates, typically in the form of a sodium salt; polyethers such as polyglycol ethers; ether sulfonates such as lauryl ether sulfonate in the form of the sodium salt; esters of phthalic acid and of its derivatives; esters of polyglycerol; amines such as triethanolamine; and esters of fatty acids, such as stearic esters, as specified in WO 01/92157 of SOLVAY BARIUM STRONTIUM GmbH.

As crystallization inhibitor it is also possible to use a compound or a salt of the formula (I) having a carbon chain R and n substituents [A(O)OH] in which
R is an organic radical which has hydrophobic and/or hydrophilic moieties, R being a low molecular mass, oligomeric or polymeric, optionally branched and/or cyclic carbon chain which optionally contains oxygen, nitrogen, phosphorus or sulphur heteratoms, and/or being substituted by radicals which are attached via oxygen, nitrogen, phosphorus or sulphur to the radical R, and
A being C, P(OH), OP(OH), S(O) or OS(O),
and n being 1 to 10 000.

In the case of monomeric or oligomeric compounds, n is preferably 1 to 5.

Useful crystallization inhibitors of this kind include hydroxy-substituted carboxylic acid compounds. Highly useful examples include hydroxy-substituted monocarboxylic and dicarboxylic acids having 1 to 20 carbon atoms in the chain (reckoned without the carbon atoms of the COO groups), such as citric acid, maleic acid (2-hydroxybutane-1,4-dioic acid), dihydroxysuccinic acid and 2-hydroxyoleic acid, for example.

Also very useful are phosphonic acid compounds having an alkyl (or alkylene) radical with a chain length of 1 to 10 carbon atoms. Useful compounds in this context are those having one, two or more phosphonic acid radicals. They may additionally be substituted by hydroxyl groups. Highly useful examples include 1-hydroxyethylenediphosphonic acid, 1,1-diphosphonopropane-2,3-dicarboxylic acid and 2-phosphonobutane-1,2,4-tricarboxylic acid. These examples show that compounds having not only phosphonic acid radicals but also carboxylic acid radicals are likewise useful.

Also very useful are compounds which contain 1 to 5 or an even greater number of nitrogen atoms and also 1 or more, for example up to 5, carboxylic acid or phosphonic acid radicals and which are optionally substituted additionally by hydroxyl groups. These compounds include, for example, those having an ethylenediamine or diethylenetriamine framework and carboxylic acid or phosphonic substituents. Examples of highly useful compounds include diethylenetriamine pentakis(methanephosphonic acid), iminodisuccinic acid, diethylenetriaminepentacetic acid and N-(2-hydroxyethyl)ethylenediamine-N,N,N-triacetic acid.

Also very useful are polyamino acids, an example being polyasparatic acid.

Also very useful are sulphur-substituted carboxylic acids having 1 to 20 carbon atoms (reckoned without the carbon atoms of the COO group) and one or more carboxylic acid radicals, an example being sulphosuccinic acid bis-2-ethylhexyl ester (dioctylsulphosuccinate).

It is of course also possible to use mixtures of the additives, including mixtures, for example, with further additives such as phosphorous acid.

Very particular preference is given to citric acid and sodium polyacrylate, such as Dispex®N40 (from CIBA), as crystallization inhibitor.

The dispersant preferably has one or more anionic groups which are able to interact with the surface of the barium sulfate. Preferred groups are the carboxylate group, the phosphate group, the phosphonate group, the bisphosphonate group, the sulfate group and the sulfonate group.

Especially preferred is chemically modified barium sulfate which comprises a dispersant with one or more carboxylate, phosphate, phosphonate sulfate or sulfonate groups interacting with the surface of the barium sulfate, and which dispersants further comprise one or more organic groups R1 which comprise hydrophobic and/or hydrophilic partial structures. R1 is preferably an oligomeric or polymeric carbon chain of lower molecular weight which optionally is branched, and which may comprise oxygen, nitrogen, phosphorus or sulfur as hetero atoms, and/or R1 is substituted by groups such as alkyl groups which can be bound to the carbon chain via oxygen, nitrogen, phosphorus or sulfur; optionally, the carbon chain or the substituent groups can be substituted by hydrophilic or hydrophobic groups. An example for such substituent groups is the polyether group. Preferred polyether groups comprise 3 to 50, preferably 3 to 40 and especially preferred 3 to 30 alkylene oxy groups. The alkylene oxy group is preferably selected from methylene oxy, ethylene oxy, propylene oxy and butylene oxy groups.

Useful nanofine barium sulfate particles may comprise an agent which comprises groups suitable to interact with polymers, e.g. OH or NH₂ groups which interact chemically, or which interact physically.

An example for dispersants which render the surface hydrophobic properties are phosphoric acid derivatives wherein one oxygen atom of the P(O) group is sub-stituted by a C3 to C10 alkyl or alkylene group, and another oxygen atom of the P(O) group is substituted by a polyether group. The remaining acid oxygen atom can interact with the surface of the nano-fine particles.

The dispersing agent can be, for example, a phosphoric acid diester with a C6 to C10 alkenyl group and a polyether group as partial structures. Phosphoric acid esters with polyether/polyester groups like the one traded under the name of Disperbyk® 111 (BYK-Chemie), phosphoric acid ester salts with polyether/alkyl groups like the one traded under the names of Disperbyk® 102 and 106 are suitable, too. Also, deflocculating agents, such as those based on high-molecular copolymers with pigment-affine groups, such as Disperbyk® 190 or polar acidic esters of long-chain alcohols like Disperplast® 1140 are suitable kinds of dispersants.

Another very preferred group of dispersants are polyether polycarboxylates substituted terminally on the polyether groups by hydroxyl groups, examples being those supplied under the name Melpers® of the company SKW/DEGUSSA (now BASF).

For the calcium carbonate particles, the organic compound can be a surfactant. The surfactant may be of cationic, nonionic or anionic type. Nonionic and anionic surfactant derivatives are preferred. The term “nonionic surfactant derivatives” is intended to denote compounds whose molecule contains at least one non-ionizable polar group and a hydrophobic chain. The nonionic surfactant derivatives that are suitable are especially condensates of an alkylene oxide with an alcohol, polyalkylene glycols and long-chain ketones such as stearone, laurone and coconone and ketones obtained by oxidation of long-chain hydrocarbons such as eicosane. The term “anionic surfactant derivatives” is intended to denote compounds whose molecules comprise at least one anionic group or a group capable of generating an anionic group, and a hydrophobic chain. Examples of hydrophobic chains are especially linear or branched alkyl chains containing from 10 to 60 carbon atoms, monoalkylbenzene and polyalkylbenzene groups and monoalkylnaphthalene and polyalkylnaphthalene groups. The anionic groups may be chosen from sulfate (—C—O—SO₃⁻), sulfonate (—C—SO₃⁻), phosphate (—C—OPO₃—), phosphonate (—C—PO₃⁻) and carboxylate (—COO⁻) groups. Derivatives whose molecules comprise a sulfonate group or a group capable of generating a sulfonate group are, for example, sodium dodecylbenzenesulfonate, dodecylbenzenesulfonic acid and tetracosylbenzenesulfonic acid. A derivative whose molecule comprises a sulfate group or a group capable of generating a sulfate group is, for example, sodium dodecylbenzenesulfate.

Polyether polycarboxylates substituted terminally on the polyether groups by hydroxyl groups, examples being those supplied under the name Melpers® of the company SKW are preferred anionic surfactants.

For the calcium carbonate particles, the organic compound can be selected from organic acids, their salts, their esters, alkylsulfates, alkylsulfosuccinates or mixtures thereof.

The organic acids can be selected from carboxylic, sulfonic and phosphonic acids. Carboxylic acids can be aromatic and aliphatic and aliphatic carboxylic acids are more preferred.

The aliphatic carboxylic acid may be any linear or branched or cyclic, substituted or non substituted, saturated or unsaturated, carboxylic acid. The aliphatic carboxylic acid has usually a number of carbon atoms greater than or equal to 4, preferably greater than or equal to 8, more preferably greater than or equal to 10 and most preferably greater than or equal to 14. The aliphatic carboxylic acid has generally a number of carbon atoms lower than or equal to 32, preferably lower than or equal to 28, more preferably lower than or equal to 24 and most preferably lower than or equal to 22.

In a first embodiment, according to the invention, the organic compound is an aliphatic carboxylic acid selected from the group of substituted, non substituted, saturated and unsaturated fatty acids or mixture thereof. More preferably it is selected from the group consisting of caproic acid, caprylic acid, capric acid, lauric acid, myristic acid, palmitic acid, stearic acid, iso-stearic acid, hydroxystearic acid, arachidic acid, behenic acid, lignoceric acid, cerotic acid, montanic acid, melissic acid, myristoleic acid, palmitoleic acid, petroselinic acid, petroselaidic acid, oleic acid, elaidic acid, linoleic acid, linolelaidic acid, linolenic acid, linolenelaidic acid, a-eleostaeric acid, b-eleostearic acid, gadoleic acid, arachidonic acid, erucic acid, brassidic acid and clupanodonic acid, mixtures thereof or salts derived therefrom. Mixtures containing mainly palmitic, stearic and oleic acids are more preferred. Mixtures called “stearine” which consist of about 30-40 wt % stearic acid, of about 40-50 wt % palmitic acid and of about 13-20 wt % oleic acid are particularly preferred.

In a second embodiment, according to the invention, the organic compound is a rosin acid. The rosin acid is preferably selected from the group consisting of levopimaric acid, neoabietic acid, palustric acid, abietic acid, dehydroabietic acid, mixtures thereof or salts derived therefrom.

In a third embodiment, the organic compound is a polyacrylic acid, a polyacrylic acid salt or a mixture thereof.

The barium sulfate particles are generally obtained by precipitation starting from various sources of barium ions and sulfate ions. The precipitation may be performed starting from solutions, suspensions or emulsions containing one or more precursors of the barium and sulfate ions. For example barium sulfate can be precipitated by reacting barium chloride or barium hydroxide solutions with alkali metal sulfate or sulphuric acid.

Usually, barium sulfate forms greater clusters after its formation by precipitation after mixing barium salts and sulfate salts or sulfuric acid. The barium sulfate can be comminuted to clusters with the size as mentioned above for example by a wet desagglomeration process. As liquid, water or an organic solvent, such as an alcohol, a hydrocarbon compound or a halo(hydro)carbon compound can be used. It is preferred to use an organic liquid which is a solvent for polycarbonate, for example methylene chloride or cyclopentanone.

The comminution can be performed for example in ball mills, planetary ball mills or mixer mills. This desagglomeration can be performed like described in DE-OS 19832304, without using a dispersant. In that process, the particles to be desagglomerated are put into a mill with loose milling bodies in the presence of a milling aid like solid carbon dioxide or frozen tetrafluoroethane. Using a ball mill, planetary ball mill or mixer mill, a secondary particle size of less than 20 nm can be achieved.

The precipitation of the barium sulfate can be performed in the presence of the envisaged crystallization inhibitor. It can be advantageous if at least part of the inhibitor is deprotonated; for example, by using the inhibitor at least in part, or in entirely, as an alkali metal salt, a sodium salt for example, or as an ammonium salt. Naturally it is also possible to use the acid and to add a corresponding amount of the base, or in the form of an alkali metal hydroxide solution.

The dispersant can be added during the actual precipitation or in a deagglomeration stage subsequent to the precipitation. The dispersant prevents reagglomeration.

The calcium carbonate particles can be obtained by various processes. Natural calcium carbonate can be processed by mechanically crushing and grading calcareous ore to obtain particles adjusted to the desired size. Synthetic calcium carbonate particles are usually prepared by precipitation. Precipitated calcium carbonate may be manufactured by first preparing a calcium oxide (quick lime) by subjecting limestone to calcination by burning a fuel, such as coke, a petroleum fuel (such as heavy or light oil), natural gas, petroleum gas (LPG) or the like, and then reacting the calcium oxide with water to produce a calcium hydroxide slurry (milk or lime), and reacting the calcium hydroxide slurry with the carbon dioxide discharged from a calcination furnace for obtaining the calcium oxide from limestone to obtain the desired particle size and shape precipitated calcium carbonate (carbonation process). Precipitation of calcium carbonate can also be carried out by adding an alkali metal carbonate starting with lime water (causticisation method) or precipitation by the addition of an alkali metal carbonate starting with solutions containing calcium chloride. Precipitated calcium carbonate obtained from the carbonation process is preferred.

The precipitation may be performed starting from solutions, suspensions or emulsions containing one or more precursors of the calcium and carbonate ions. Emulsion precipitation is preferred. The term “emulsion” is intended to denote the division of a liquid in the form of fine droplets in another liquid. Emulsions generally contain an aqueous liquid phase and an organic liquid phase. Emulsions consisting of fine droplets of aqueous phase in an organic liquid phase are preferred. When the droplets are of micrometric size or less, the systems concerned are known as microemulsions. The term “micrometric size or less” is intended to denote a size of less than or equal to 1 μm, preferably less than or equal to 0.5 μm, particularly preferably less than or equal to 0.25 μm and most particularly preferably less than or equal to 0.1 μm. Microemulsion precipitation is more particularly preferred.

Without wishing to be bound by any theoretical explanation, it is thought that the precipitation takes place in the microdroplets of the aqueous liquid phase and that the size of the droplets defines the size of the calcium carbonate nanoparticles.

The invention also relates to transparent polymer composition comprising at least one polymer in which nanoparticles of barium sulfate or calcium carbonate with a particle size of less than or equal to 150 nm and greater than or equal to 0.5 nm have been incorporated.

The invention also relates to transparent polymer compositions comprising at least one polymer in which calcium carbonate nanoparticles with a mean equivalent spherical diameter measured by the small-angle X-ray scattering (SAXS) technique of less than or equal to 70 nm and greater than or equal to 0.5 nm have been incorporated.

The term “polymer compositions” is intended to denote compositions comprising at least 10% by weight of at least one polymer. The term “polymer” is used in its generally accepted sense and invariably denotes a homopolymer, a copolymer or a blend of homopolymers and/or copolymers. Oligomers are also here considered as polymers.

The term “transparent polymer compositions” is intended to denote polymer compositions which, in the form of a plate 4 mm thick, allow at least 75%, preferably at least 85%, particularly preferably at least 90% and most particularly preferably at least 93% of visible light radiation to pass through. The transparency measurement is performed according to ASTM standard D 1746-03 (2003).

When the polymer can not be processed as plate 4 mm thick, the term “transparent polymer compositions” is intended to denote polymer compositions which, in the form of a film 100 μm thick, allow at least 80%, preferably at least 90%, particularly preferably at least 95% and most particularly preferably at least 99% of visible light radiation to pass through. The transparency measurement is performed according to ASTM standard D 1746-03 (2003).

The polymer can be a crystalline or an amorphous polymer.

By crystalline polymer, one intends to denote a polymer which has a crystallinity as measured according to Standard ASTD D 3418-03 higher than or equal to 15%, preferably higher than or equal to 50%, more preferably higher than or equal to 90% and most preferably higher than or equal to 95%. By amorphous polymer, one intends to denote a polymer which has a crystallinity lower than 15%, preferably lower than or equal to 5%, more preferably lower than or equal to 1% and most preferably lower than or equal to 0.5%. Amorphous polymers are preferred.

These polymers may be selected from polyolefins, vinyl polymers, epoxy resins, silicones, polyurethanes, polyamides, saturated and unsaturated polyesters, polysulfones, cellulose-based polymers, aminoplasts, polycarbonates, copolymers of an α-olefin and of a vinyl monomer, and terpolymers, and mixtures thereof.

These polymers are preferably selected from epoxy resins, polyamides, polysulfones, cellulose-based polymers, aminoplasts and polycarbonates.

The polyolefins may be selected from polymethylpentene, polystyrene, natural and synthetic rubbers, and copolymers based on cyclic olefins. Polymethylpentene, polystyrene and copolymers based on cyclic olefins are preferred.

The vinyl polymers preferably do not contain chlorine atoms. These vinyl polymers are preferably selected from polyvinyl acetate and polymethyl methacrylate.

The silicone may be a modified silicone.

The saturated polyester may be polyethylene terephthalate or polynaphtalene terephtalate.

The copolymers of α-olefin and of a vinyl monomer may be selected from ethylene-vinyl alcohol copolymers, styrene-acrylonitrile copolymers and styrene-methyl methacrylate copolymers.

The terpolymer may be an acrylonitrile-butadiene-styrene copolymer.

Transparent polymer compositions in which the polymer is an epoxy resin or a polycarbonate are particularly preferred, with polycarbonate being the most preferred.

Epoxy resins are organic compounds, generally oligomeric, having more than one epoxide group per molecule. These oligomeric compounds can, using suitable hardeners, be converted into thermosets. Epoxy resins are used as, for example, casting resins or else as laminates (in aircraft, vehicle or watercraft construction, for example).

Monoepoxide compounds used as starting material for producing epoxy resins are, in particular, epichlorohydrin, but also glycidol, styrene oxide, cyclohexene oxide, and glycidol acrylate and methacrylate. Resin is formed by reaction, especially with bisphenol A. For specific resins, other polyols, such as aliphatic glycols, are also suitable. Liquid resins may also be chain-extended by the “advancement” method. Examples of suitable curing agents include dicarboxylic anhydrides or amine hardeners. An elucidation of principles is found for example in Ullmanns Enzyklopädie der Technischen Chemie, 4^{th} edition, volume 10, pages 563-580 and in Kirk-Othmer, Encyclopedia of Chemical Technology, 4th edition, volume 9, pages 730-755.

Epoxides which are highly suitable are those based on bisphenol A and epichlorohydrin. They may also include admixtures, examples being reaction products of bisphenol F (bis(3-chloro-2-hydroxypropyl) ether) and epichlorohydrin or glycidyl ethers, 1,6-hexanediol diglycidyl ether for example. Very useful epoxides are those with 50% to 100% by weight of bisphenol A/epichlorohydrin, 0% to 50% by weight, preferably 10% to 25% by weight, of bisphenol F/epichlorohydrin, and 0% to 50% by weight, preferably 10% to 25% by weight, of 1,6-hexanediol glycidyl ether. One commercial product with such a composition is Epilox M730® resin (LEUNA-HARZE GmbH).

Examples of highly suitable hardeners include those based on polyoxyalkylenamines. It is also possible to employ mixtures, examples being mixtures of the polyoxyalkyleneamines with cyclohexanediamines or piperazinylethylamines. A very useful hardener, for example, is one with 50% to 100% of polyoxyalkyleneamine, 0% to 50% by weight, preferably 10% to 25% by weight, of 1,2-cyclohexanediamine (also as an isomer mixture), and 0% to 50% by weight, preferably 10% to 25% by weight, of 2-piperazin-1-ylethylamine. One commercial product with such a composition is Epilox M888® (LEUNA-HARZE GmbH).

The cured epoxy resins of the invention may comprise further typical constituents such as, for example, curing accelerants or pigments. When the transparent polymer is an epoxy resin, the invention addresses the uncured and/or the cured compound.

Polycarbonates are polyesters of dicarboxylic acids with aliphatic and aromatic dihydroxy compounds. Examples of aromatic dihydroxy compounds are 2,2-bis(4-hydroxyphenyl)propane (Bisphenol A), 1,1-bis(4-hydroxyphenyl)cyclohexane (Bisphenol C), 2,2-bis(3,5-dibromo-4-hydroxyphenyl)propane (tetrabromobisphenol A) and 2,2-bis(3,5-dimethyl-4-hydroxyphenyl)propane (tetramethylbisphenol A) and 1,1-bis(4-hydroxyphenyl)-3,3,5-trimethylcyclohexane (BPTMC) and mixtures thereof.

Bisphenol A is a preferred dihydroxy compound. Aromatic polyester blocks, aliphatic polyether blocks, and polysiloxane blocks may also be co-condensed with Bisphenol A.

Commercial polycarbonates are for example the Makrolon® polycarbonate resin from BAYER.

The content of barium sulfate or calcium carbonate nanoparticles in the polymer compositions is generally greater than or equal to 0.5% by weight of the total composition, often greater than or equal to 1% by weight, frequently greater than 5% by weight and most particularly greater than or equal to 10% by weight. This content is usually less than or equal to 90% by weight, usually less than or equal to 75% by weight, often less than or equal to 50% by weight, frequently less than or equal to 25% by weight and especially less than or equal to 20% by weight.

The polymer compositions may also contain other components known in the art generally such as for examples heat stabilizers, plasticizers, impact modifiers, lubricants, flame retardants, pigments, microbiocides, anti-oxidants, light stabilizers and processing aids.

The use of barium sulfate or calcium carbonate nanoparticles as filler in transparent polymer compositions gives these compositions improved properties, such as impact bending strength, strain at break, Young Modulus, Flexural modulus, scratch resistance, tensile strength, impact resistance, heat stability and visible and UV radiation stability.

The invention also relates to a process for manufacturing transparent polymer compositions by dispersing nanoparticles of barium sulfate or calcium carbonate in a transparent polymer. Any known methods for dispersing solids into polymers can be used, like for instance, melt blending, solvent blending, in situ polymerization or combination thereof.

The barium sulfate or calcium carbonate nanoparticles may be mixed with the polymer during a process of forming the polymer, such as extrusion, injection-moulding, blow-moulding, roto-molding and calendaring. The barium sulfate or calcium carbonate nanoparticles may in this case be used in the form of a dispersion in a solvent or in the form of a powder.

The barium sulfate or calcium carbonate nanoparticles may be mixed with at least one monomer before polymerizing this monomer. The barium sulfate or calcium carbonate nanoparticles may in this case be used in the form of a dispersion in a solvent or in the form of a powder. Melt blending and extrusion techniques are described in Plastic, Processing (Gert Burkhardt, Ulrich Hüsgen, Matthias Kalwa, Gerhard Pötsch, Claus Schwenzer, Germany, Ullmann's Encyclopedia of Industrial Chemistry, VCH Publishers, Inc., 1992, Vol. A 20, pp 664-756).

The process for manufacturing transparent polymer compositions, comprises the following steps:
a. Preparation of powders or suspensions of barium sulfate or calcium carbonate nanoparticles with a particle size of less than or equal to 150 nm and greater than or equal to 0.5 nm and,
b1. Mixing of the powders or of the suspensions of the barium sulfate or calcium carbonate nanoparticles obtained in step (a) with at least one polymer or
b2. Mixing of the powder or the suspensions of the barium sulfate or calcium carbonate nanoparticles obtained in step (a) with at least one monomer and polymerization of this monomer.

According to a first specific aspect, the process for preparing the polymer composition comprises the following steps:
1. the polymer component is dissolved in a solvent so as to form a solution of the polymer component in the solvent
2. the barium sulfate or calcium carbonate nano particles are introduced in the solution of step 1 after or during the dissolution, so as to produce a first suspension,
3. a non-solvent of the polymer component is injected in the first mixture of step 2 so as to precipitate the polymer component and to produce a second suspension of an intimate mixture of the polymer component and barium sulfate or calcium carbonate nano particles
4. the intimate mixture of step 3 is filtrated so as to obtain a solid
5. the solid filtrated in step 4 is dried.

According to a first variant of that first aspect, the non-solvent is introduced in liquid form. Such a process is described in patent application WO 03/064504 of SOLVAY SA the content of which is incorporated herein by reference. The solvent is preferably an organic solvent and the non solvent is preferably water.

According to a second variant of that first aspect, the non-solvent is introduced in a liquid form in a quantity such that no inversion of phase occurs and further introduced at least partially in the form of vapor. Such a process is described in patent application WO 05/014705 of SOLVAY SA the content of which is incorporated herein by reference. The solvent is preferably an organic solvent and the non solvent is preferably water and the vapor is preferably steam.

According to a second specific aspect, the process for manufacturing transparent polymer compositions, comprises the following steps:
(a) Preparation of calcium carbonate nanoparticles with a particle size of less than or equal to 150 nm and greater than or equal to 0.5 nm, by
   i. preparation of an emulsion of an aqueous phase in an organic phase, in which the emulsion contains a surfactant derivative and a source of calcium ions,
   ii. optionally, preparation of an emulsion of an aqueous phase in an organic phase, in which the emulsion contains a surfactant derivative and a source of carbonate ions
   iii. mixing of the emulsion prepared in step i with carbon dioxide or with the emulsion prepared in step ii
   iv. distillation of the mixture obtained in step iii to separate it into at least a light fraction and a heavy fraction, the calcium carbonate nanoparticles being in the heavy fraction, and recovery of the heavy fraction
   v. precipitation of the calcium carbonate nanoparticles in the heavy fraction from step iv
   vi. separation and drying of the precipitated calcium carbonate nanoparticles from step v to obtain a powder
   vii. optionally, dispersion of the powder in an organic solvent.
(b1)Mixing of the powder of calcium carbonate nanoparticles obtained in step (a vi) or of the dispersion of the powder in a solvent obtained in step (a vii) with at least one polymer
(b2) Mixing of the powder of calcium carbonate nanoparticles obtained in step (a vi) or of the dispersion of the powder in a solvent obtained in step (a vii) with at least one monomer and polymerization of this monomer.

The emulsion of step (a i) can be replaced by a suspension of a solid calcium component in an organic phase which contains a surfactant derivative.

The sources of calcium ions may be selected from calcium oxide (quicklime), calcium hydroxide (slaked lime), and calcium chloride, and mixtures thereof. The sources of carbonate ions are, for example, alkali metal or alkaline-earth metal carbonates or bicarbonates and carbon dioxide. Carbon dioxide can be used pure or diluted, as a gas, as a liquid or as a solid.

In a first embodiment of this second specific aspect of the process according to the invention, calcium oxide or hydroxide is used in step (a i), an alkali metal carbonate is used in step (a ii), and the emulsion prepared in step (a i) is mixed with the emulsion prepared in step (a ii).

In a second embodiment of this second specific aspect of the process according to the invention, which is preferred, calcium oxide or hydroxide is used in step (a i) and gaseous carbon dioxide is used in step (a iii).

The calcium oxide (quicklime) may be obtained via any process, for instance calcination of limestone. The calcium hydroxide may be obtained by reacting calcium oxide with water to produce a solid or a solution (lime water) or a suspension (lime milk, LM) of calcium hydroxide.

The carbon dioxide may originate from calcination ovens used to produce the quicklime or may originate from thermal stations or alternatively from liquid CO₂ reservoirs. Carbon dioxide originating from calcination ovens used to produce the quicklime starting from limestone is preferred.

The organic phase generally comprises an aromatic hydrocarbon and a hydrocarbon-based oil with a boiling point of greater than 150° C. and a light alcohol and optionally water.

The aromatic hydrocarbon is, for example, toluene.

The alcohol may be selected from alcohols with an alkyl, alkylaryl or aralkyl chain containing from 1 to 10 carbon atoms. Examples of alcohols are methanol and alkyl phenols.

The surfactant derivative has been described above.

The light fraction recovered in step iv generally comprises compounds with a boiling point of less than or equal to 150° C.

The heavy fraction recovered in step (a iv) generally comprises compounds with a boiling point of greater than 150° C. and calcium carbonate nanoparticles. The precipitation of the calcium carbonate nanoparticles in the heavy fraction from step iv is generally performed by adding a polar solvent, for instance a ketone.

Before the precipitation of the calcium carbonate nano particles, the heavy fraction from step (a iv) can be submitted to a separation operation, for instance, a centrifugation, to remove solid particles which are not calcium carbonate nano particles, from the heavy fraction.

The separation of the calcium carbonate nanoparticles precipitated in step (a v) is performed by any means, for example by filtration or centrifugation. Centrifugation is preferred.

The drying of the precipitated calcium carbonate nanoparticles is performed by any means.

The nanoparticles isolated in solid form may be redispersed in any solvent. It has been discovered, surprisingly, that the dispersions obtained are transparent. The solvent may be chosen from organic and inorganic solvents. Organic solvents are preferred.

The invention thus also relates to transparent dispersions comprising an organic solvent, into which aggregates comprising at least one organic derivative and consisting of calcium carbonate nanoparticles with a particle size of less than or equal to 150 nm and greater than or equal to 0.5 nm have been incorporated, to a proportion of more than 0.5% by weight.

The term “transparent dispersions” is intended to denote dispersions not having any turbidity according to ISO standard 15715 (2003).

The organic solvent may be polar or non-polar. The polar solvents may be selected from alcohols and ketones. The non-polar solvents may be selected from aromatic and aliphatic hydrocarbons. An example of a non-polar solvent is toluene.

The content of calcium carbonate nanoparticles in the solvent is usually greater than 5% by weight, often greater than or equal to 10% by weight, frequently greater than or equal to 15% by weight and particularly greater than 25% by weight.

In these compositions, the calcium carbonate nanoparticles have a particle size distribution (PSD) such that 90% by weight, preferably 95% by weight and particularly preferably 99% by weight of the particles have an ESD measured by SAXS of greater than or equal to 90% and less than or equal to 110% of the mean ESD.

The examples that follow serve to illustrate the invention without, however, limiting the scope of the claims.

### EXAMPLE 1 (ACCORDING TO THE INVENTION)

### Preparation of Calcium Carbonate Nanoparticles Used in the Invention

The synthesis is performed in a 500 mL glass reactor at room temperature, with magnetic stirring using a magnetic bar.
a) Tetracosylbenzenesulfonic acid (46.5 g) is mixed with toluene (46 g), methanol (26.6 g) and EXXSOL®D80 (150 g). The whole is stirred at room temperature.
b) 30 g of calcium hydroxide slaked lime (Ca(OH)₂) are then added slowly.
c) Carbon dioxide is bubbled directly into the mixture, with stirring for 55 minutes.

A very viscous brown/black liquid is obtained.

A solid and a supernatant are separated by centrifugation. 10 ml of this supernatant are mixed with 3 ml of heptane. 3 ml of acetone are then added. The resulting mixture is centrifuged for 1 hour at 2000 rpm. The supernatant is separated from the centrifugation pellet.

The preceding operation is repeated twice and a solid yellow product is finally isolated.

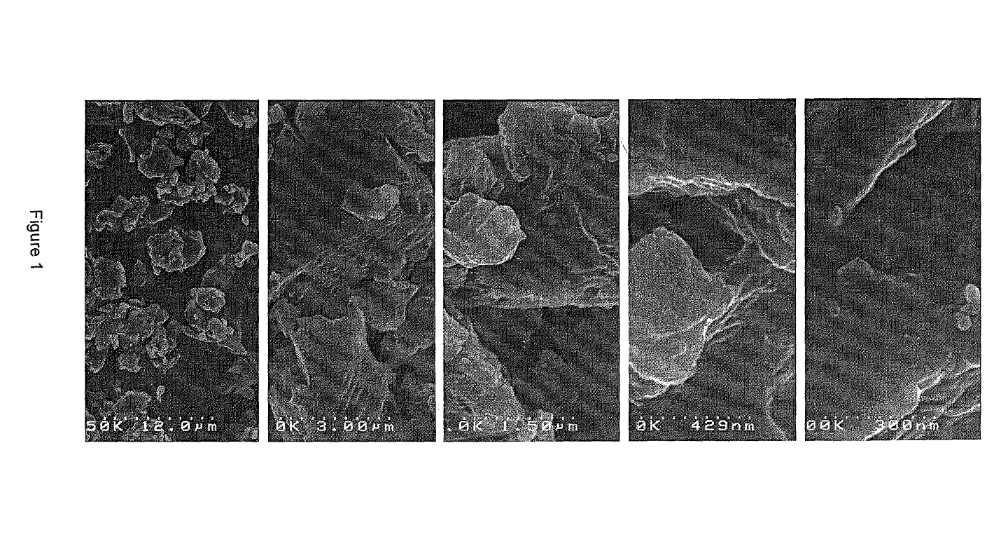

FIG. 1 is a photograph by scanning microscopy of the solid obtained.

### EXAMPLE 2 (ACCORDING TO THE INVENTION)

### Dispersion of Calcium Carbonate Nanoparticles in Toluene

The solid product isolated in the preceding example is mixed with toluene to a proportion of 17% by weight. The mixture is perfectly transparent by visual observation.

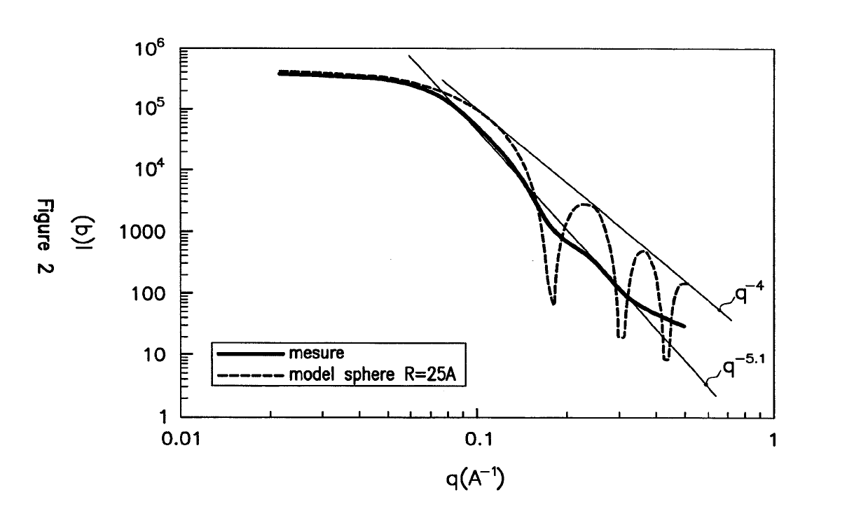

The SAXS spectrum of the toluene suspension is represented in FIG. 2 is typical of spheres with a mean equivalent spherical diameter (ESD) of 5 nm and a particle size distribution (PSD) such that 99% by weight of the particles have an ESD of greater than or equal to 90% and less than or equal to 110% of the mean ESD.

The average particle size measured by Dynamic Light Scattering is 7 nm.

### EXAMPLES 3 TO 4 (ACCORDING TO THE INVENTION)

### Preparation of Nanoparticles of Barium Sulfate

The barium sulphate nano particles with the characteristics summarized in Table 1 have been obtained.

Barium sulfate nano particles have been obtained following example 1 of patent application WO 2005/054133 of SOLVAY BARIUM STRONTIUM GmbH.

The polyacrylate is Dispex® N40 from CIBA (BaSO₄). The phosphoric acid ester is Disperbyk® 102 from BYK GmbH. The polyethercarboxylate is Melpers® 0030 from BASF.

### EXAMPLES 5 TO 7 (ACCORDING TO THE INVENTION)

### Preparation of Nanoparticles of Calcium Carbonate

The calcium carbonate nano particles with the characteristics summarized in Table 1 have been obtained.

The calcium carbonate of example 5 has been obtained following example 1 of U.S. Pat. No. 6,342,100 of SOLVAY SA except that the milk of lime contained 2% of EDTA before carbonation and that the dried solid has been further coated with a polyethercarboxylate (Melpers® 0030 from BASF).

The calcium carbonate of example 6 has been obtained following example 1 of U.S. Pat. No. 6,342,100 of SOLVAY SA.

The calcium carbonate of example 7 has been obtained following examples 1 to 3 of U.S. Pat. No. 6,342,100 of SOLVAY SA.

### EXAMPLES 8 TO 11 (ACCORDING TO THE INVENTION)

### Hardened Epoxy Resins Containing Barium Sulphate and Calcium Carbonate Nano Particles

### Step 1

Nano particles of barium sulphate of example 3 and nano particles of calcium carbonate of example 5 have been mechanically dispersed in butanol (40% wt of solid) in a pearl mill by using a dispersing additive (polyethercarboxylate Melpers® 0030 from SKW/DEGUSSA). The dispersions exhibit low viscosity, are optically very transparent (visual inspection) and the average particle diameter D₅₀ of the particle size distribution measured by Centrifugal liquid Sedimentation (Standard ISO 13318-2, 2001) is 68 nm for barium sulfate and 51 nm for calcium carbonate.

### Step 2

The dispersions obtained in step 1 have been mixed with Araldite LY 556 (a bisphenol-A based epoxy resin from HUNTSMAN ) and the solvent has been removed under vacuum at 60° C. to give masterbatches of filled epoxy resins with 50% wt of filler. Layers of 120 μm thickness of both filled epoxy resins deposited on glass plate are transparent by visual inspection.

### Step 3

The filled epoxy resins of step 2 (2 up to 20%) have been mixed with Araldite LY 556 (100 parts by wt ), Aradur HY 917 (a phthalic acid anhydride based hardener from HUNTSMAN, 0.98 parts by wt) and DY 070 (a methylimidazole accelerator from HUNTSMAN, 0.5 parts by wt), casted as 2 mm thick plates and then cured at 4 h at 80° C. and 4 h at 120° C.

### EXAMPLE 12 (NOT ACCORDING TO THE INVENTION)

### Hardened Epoxy Resins Without Barium Sulfate Nano Particles and Without Calcium Carbonate Nanoparticles

Hardened epoxy-resins free of barium sulfate and free of calcium carbonate have been prepared according to step 3 of the previous examples.

### Testing

The filled (examples 8 to 11) and unfilled (example 12) hardened (cured) materials have been tested for transparency by visual inspection, for dispersion using Scanning and Transmission Electron Microcopy techniques and for impact bending strength using Standard DIN ISO 179-1 Type 1 (2000), strain at break, Young Modulus and tensile strength according to standard ISO DIN ISO 527-4 (1997).

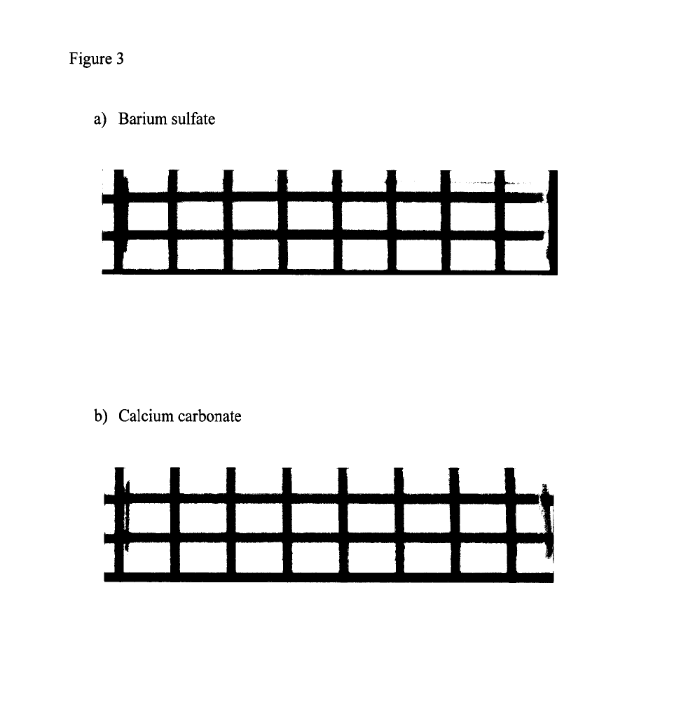

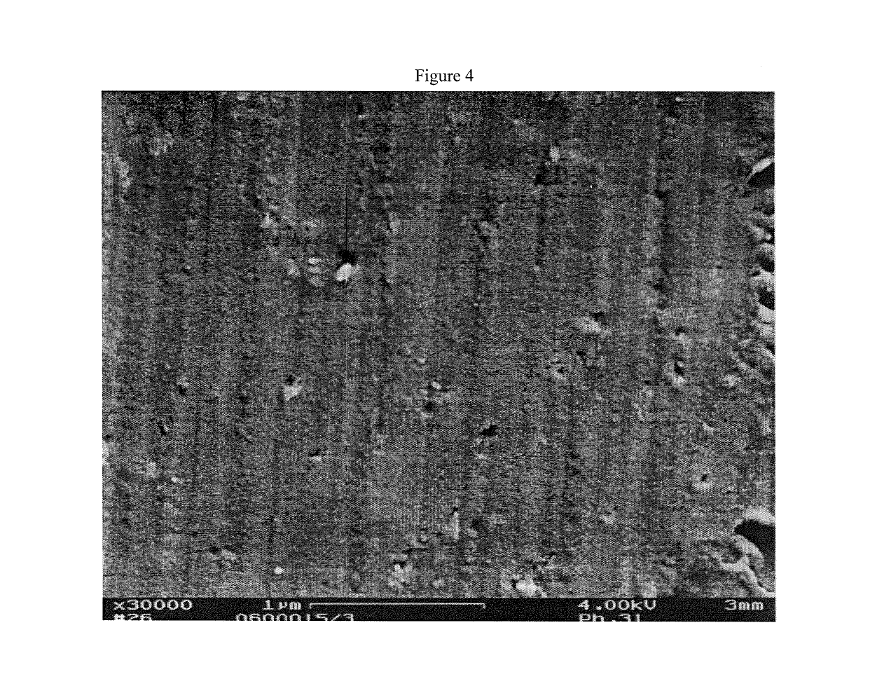

FIG. 3 shows the transparency test results for hardened epoxy resins containing 2.5% wt of barium sulphate (a) and of calcium carbonate (b). FIG. 4 show a SEM picture of a hardened epoxy resin with 2.5% wt of calcium carbonate.

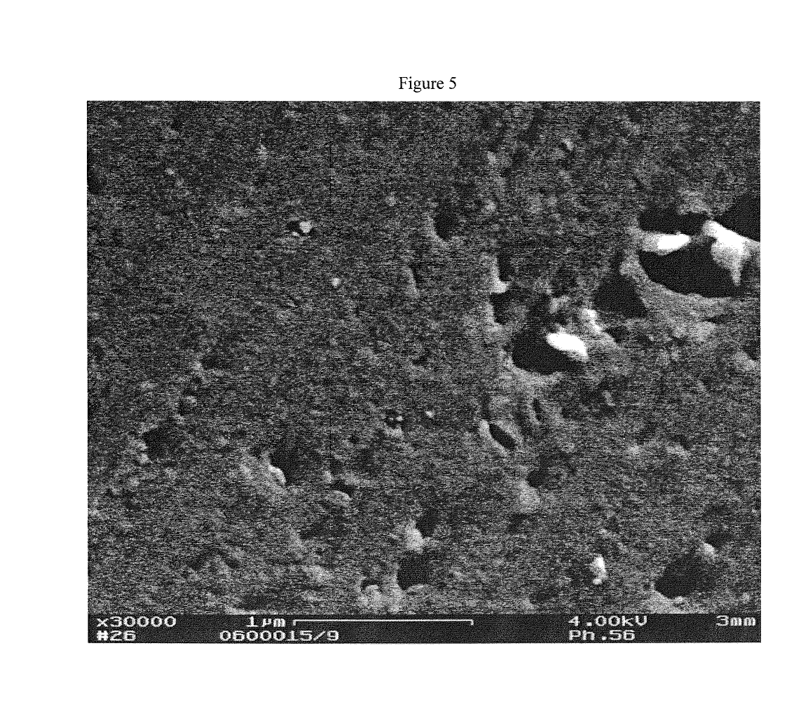

FIG. 5 show a SEM picture of a hardened epoxy resin with 2.5% wt of barium sulfate.

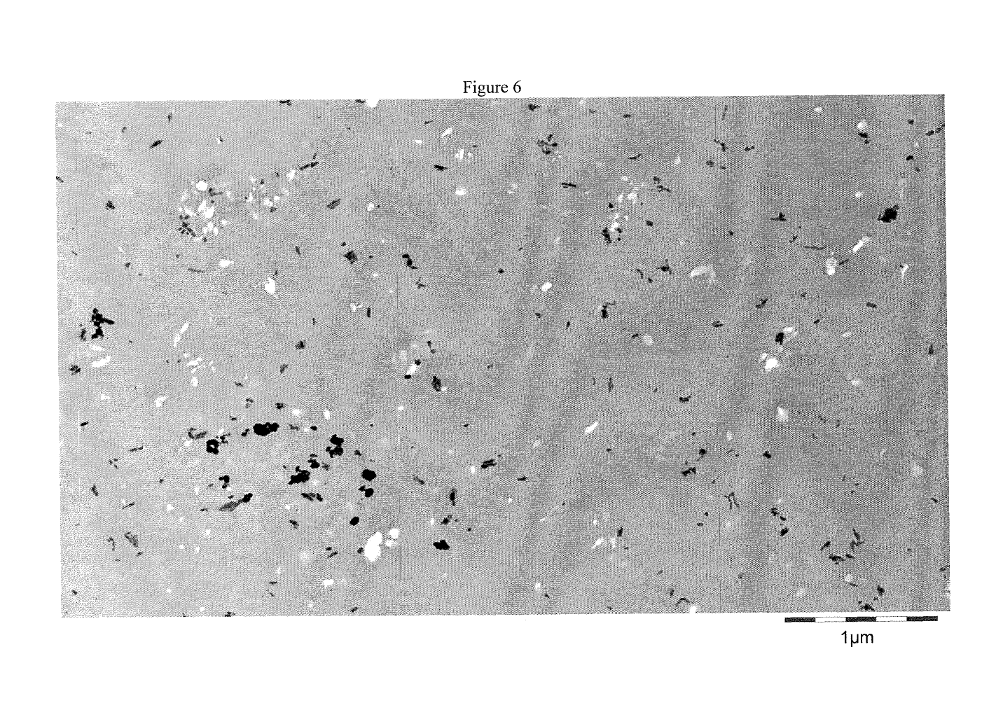

FIG. 6 show a TEM picture of a hardened epoxy resin with 2.5% wt of calcium carbonate.

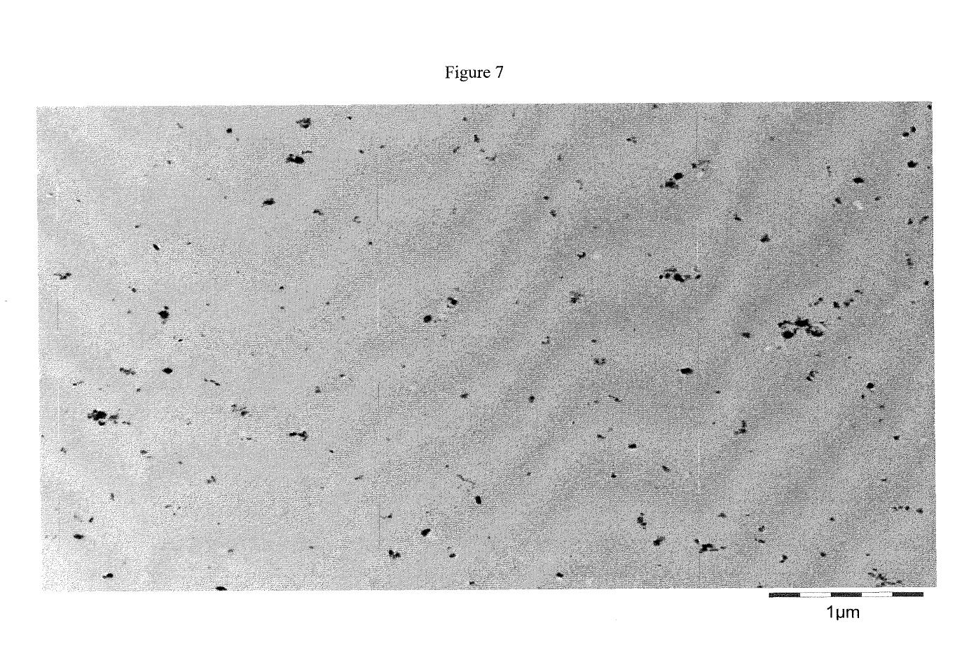

FIG. 7 show a TEM picture of a hardened epoxy resin with 2.5% wt of calcium carbonate.

Table 2 summarizes the mechanical tests results.

### EXAMPLE 13 (ACCORDING TO THE INVENTION)

### Polycarbonate Containing Barium Sulfate Nano Particles

### Step 1

Masterbatches of polycarbonate containing nanoparticles of barium sulfate have been prepared by mixing nano barium sulfate of example 4 with polycarbonate (Makrolon 2205, BAYER) following the procedure described in WO 05/014705 and WO 03/064504 of SOLVAY SA.

### Step 2

A polycarbonate containing nanoparticles of barium sulfate has been prepared by extruding (CLEXTRAL BC21) and pelletizing (SCHEER 50 granulator) mixtures of neat polycarbonate and of the masterbatches prepared in step 1. The content of barium sulphate is 6 phr (parts per hundred of resin).

### EXAMPLE 14 (NOT ACCORDING TO THE INVENTION)

### Polycarbonate Without BaSO₄ Nano Particles

The same experiment has been repeated as in example 13 except that no barium sulfate has been added at step 1.

### Testing

Samples have been prepared and tested for the Scratch resistance (Standard ISO 1518 (2001), apparatus form Sheen, load of 2000 g), for the Flexural Modulus (Standard ISO 178, speed of 1 mm/min, segment module taken between 0.05% and 0.25% of the curve) and for the impact resistance (standard ISO 899). The results are reported in Table 3.

### EXAMPLES 15 AND 16 (ACCORDING TO THE INVENTION)

### Polycarbonate Containing CaCO₃ Nano Particles

The precipitated calcium carbonate nanoparticles of examples 6 and 7 have been used.

A polycarbonate polymer (Makrolon AL 2647 from BAYER, 100 g) has been introduced in a mixer (BRABENDER GmbH and Co.) at 280° C. and kept for 1 minute after complete melting of the polymer before introducing the calcium carbonate (1 g) of example 6 (polycarbonate of example 15) or of example 7 (polycarbonate of example 16). The resulting mixture has been mixed for 8 minutes at the 280° C. The hot mixture has then been transferred to a press and pressed to obtain plates with a few mm thickness.

The plates have been tested for transparency according to standard DIN 6174. The L parameter derived from the Cielab formula normalized to length unit is taken as a measure of the transparency of the plates. The results are summarized in Table 4.

TABLE 1

| | | | | |
|---|---|---|---|---|
| | | | | Organic |
| S_{BET} | Size^{a} | Size^{b} | Size^{c} | compound |

| | | | | | |
|---|---|---|---|---|---|
| Example | (m²/g) | (nm) | (nm) | (nm) | (wt %) |

| | | | | | | |
|---|---|---|---|---|---|---|
| 3 | BaSO₄ | 47 | 36 | 68 | — | 11.5^{e} |
| 4 | BaSO₄ | 43 | 42 | 121 | — | 18^{d} |
| 5 | CaCO₃ | 61 | 21 | 51 | — | 5^{f}- |
| 6 | CaCO₃ | 20 | — | — | 70 | — |
| 7 | CaCO₃ | 19 | — | — | 70 | 2.9^{g} |

^{a}X-ray diffraction line broadening
^{b}Centrifugal liquid Sedimentation
^{c}Air permeation
^{d}3% of polyacrylate, 15% of phosphoric acid ester
^{e}3% of polyacrylate, 8.5% of polyethercarboxylate
^{f}2% of EDTA, 3% of polyethercarboxylate
^{g}2.9% stearic acid

TABLE 2

| | Nano | | Impact | Strain | | |
|---|---|---|---|---|---|---|
| Epoxy | BaSO₄ or | Filler | bending | at | Young | Tensile |
| resin | CaCO₃ | content | strength | break | Modulus | strength |
| Example | Example | (wt %) | (kJ/m²) | (%) | (MPa) | (MPa) |
| 12 | — | 0 | 30.9 | 2.36 | 3140 | 64.0 |
| 8 | 3 | 2.5 | 49.5 | 3.66 | 3036 | 80.3 |
| 9 | 5 | 2.5 | 36.1 | 3.46 | 3163 | 80.5 |
| 10 | 3 | 10 | 25.7 | 2.46 | 3266 | 64.2 |
| 11 | 5 | 10 | 31.8 | 2.99 | 3362 | 78.3 |

TABLE 3

| | Nano | | | | |
|---|---|---|---|---|---|
| Poly | BaSO₄ | Scratch | Flexural | Impact resistance | |
| carbonate | Ex- | resistance | Modulus | (J/mm) | |
| Example | ample | (2 kg) (μm) | (MPa) | At 23° C. | At −20° C. |
| 14 | — | 16.2 | 2760 | 30.575 | 25.368 |
| 13 | 4 | 14.2 | 2962 | 26.448 | 24.390 |

TABLE 4

| Poly | Nano | Plate | | |
|---|---|---|---|---|
| carbonate | CaCO₃ | thickness, | | L/e |
| Example | Example | e (mm) | L | (mm⁻¹) |
| 15 | 6 | 1.959 | 79.15 | 40.38 |
| 16 | 7 | 1.676 | 74.70 | 44.46 |

1. A method of use of nanoparticles of barium sulfate or of calcium carbonate, with a particle size of less than or equal to 150 nm and greater than or equal to 0.5 nm, as filler in transparent polymer compositions.

2. A method of use according to claim 1, wherein the barium sulfate or the calcium carbonate are precipitated barium sulfate or precipitated calcium carbonate.

3. A method of use according to claim 1, wherein the nanoparticles of barium sulphate used are in the form of clusters, at least 90% of the clusters having a size of less than 2 μm, as measured by scanning electron microscopy.

4. A method of use according to claim 1, wherein the nanoparticles of calcium carbonate used are in the form of clusters whose largest dimension is greater than or equal to 1 nm and less than or equal to 40 μm and whose smallest dimension is greater than or equal to 0.5 nm and less than or equal to 10 μm, as measured by scanning electron microscopy.

5. A method of use according to claim 1, wherein the particles contain at least one organic compound and in which the content of organic compound is greater than or equal to 0.01% and less than or equal to 90% of the total weight of the particles.

6. A method of use according to claim 5, wherein the organic compound contains at least one group capable of generating an anionic group selected from sulfate, sulfonate, phosphate, phosphonate and carboxylate groups.

7. A transparent polymer composition comprising at least one polymer in which nanoparticles of barium sulfate or of calcium carbonate with a particle size of less than or equal to 150 nm and greater than or equal to 0.5 nm have been incorporated.

8. A composition according to claim 7, wherein the polymer is selected from polyolefins, vinyl polymers, epoxy resins, silicones, polyurethanes, polyamides, saturated and unsaturated polyesters, polysulfones, cellulose-based polymers, aminoplasts, polycarbonates, copolymers of an α-olefin and of a vinyl monomer, and terpolymers, and mixtures thereof, and in which the nano particles of barium sulphate or of calcium carbonate have been incorporated, in a proportion of more than 0.5% by weight.

9. The composition according to claim 8, wherein the polyolefins are selected from polymethylpentene, polystyrene, natural and synthetic rubbers and copolymers based on cyclic olefins, and in which the vinyl polymers are selected from vinyl polymers not containing chlorine atoms, preferably from polyvinyl acetate and polymethyl methacrylate, and in which the silicone is a modified silicone, and in which the saturated polyester is selected from polyethylene terephthalate and polynaphtalene terephtalate, and in which the copolymers of an α-olefin and of a vinyl monomer are selected from ethylene-vinyl alcohol copolymers, styrene-acrylonitrile copolymers and styrene-methyl methacrylate copolymers, and in which the terpolymer is an acrylonitrile-butadiene-styrene copolymer.

10. A process for manufacturing transparent polymer compositions, comprising the following steps:
a. Preparation of powders or suspensions of barium sulfate or calcium carbonate nanoparticles with a particle size of less than or equal to 150 nm and greater than or equal to 0.5 nm and,
b1. Mixing of the powders or of the suspensions of the barium sulfate or calcium carbonate nanoparticles obtained in step (a) with at least one polymer or
b2. Mixing of the powder or the suspensions of the barium sulfate or calcium carbonate nanoparticles obtained in step (a) with at least one monomer and polymerization of this monomer.

11. The process according to claim 10, wherein the mixing in step b1 or b2 is performed during a process of forming the polymer such as extrusion, injection-moulding, blow-moulding, roto-moulding and calendaring.
